(19) United States
(12) Patent Application Publication
(10) Pub. No.: US 2025/0055873 A1
(43) Pub. Date: Feb. 13, 2025

(54) PROCESS FOR ENHANCING NETWORK SECURITY

(71) Applicant: RONALD D. HURRY, NORTH WALES, PA (US)

(72) Inventor: RONALD D. HURRY, NORTH WALES, PA (US)

(21) Appl. No.: 18/798,532

(22) Filed: Aug. 8, 2024

Related U.S. Application Data
(60) Provisional application No. 63/518,497, filed on Aug. 9, 2023.
(60) Provisional application No. 63/563,774, filed on Mar. 11, 2024.
(60) Provisional application No. 63/562,825, filed on Mar. 8, 2024.

(51) Int. Cl. H04L 9/40

(52) U.S. Cl. CPC H04L 63/1433

(57) ABSTRACT

A process for enhancing network security includes collecting network configuration and network environment information from users, including the identification of suppliers of goods and services. The collected information is parsed to identify individual security risks and a value is assigned to each security risk identified. A cumulative security score is calculated for each user using the values assigned to each security risk, and suggestions are offered to improve security.

### CROSS-REFERENCE TO RELATED APPLICATIONS

This application claims the priorities of U.S. Provisional Patent Application 63/518,497, filed Aug. 9, 2023, U.S. Provisional Patent Application 63/562,825, filed

Mar. 8, 2024, and 63/563,774, filed Mar. 11, 2024, all of which are incorporated herein in their entireties by reference.

### BACKGROUND OF THE INVENTION

### 1. Field of the Invention

The present invention relates to the assessment and provision of security systems for computer networks, and in particular to the implementation of the Zero-Trust security model.

### 2. Brief Summary of the Prior Art

Zero-Trust is an ambiguous network security concept that can be applied to many competing models, methodologies, and platforms. Each approach has different components and is specialized for specific use cases. A customized approach offers advantages and disadvantages depending on the function and functionality of the platform.

Given the complexity of the threats that computer networks connected to the internet face, quantifying the security risk environment of a computer network can be an onerous task. One attempt to do so is disclosed in U.S. Patent Publication 2024/0163312 (“Azad”), which provides a system for calculating a security risk score based on analyzing a network based on the status of security licenses active on the network and the configuration settings of security policies enabled on the network. While this process provides useful information about the security status of a securable network, such as those under the control of a single organization, in the real world, such networks must permit connection and the exchange of data with unsecured networks, or at least external networks for which a security assessment is unavailable.

Securing networks can be a continuous process, as new threats continuously arise, and attempting to patch and/or update security reflecting changes in network device locations, personnel to be authorized, network reconfiguration becomes unremittingly onerous. Provisioning a network with a Zero-Trust level of security can also be onerous.

Consequently, there is a need for tools commensurate to the task. In particular, there is a need for a tool providing a rapid assessment of the security status of a network open to connection with networks whose security status cannot be confirmed.

### SUMMARY OF THE INVENTION

In one presently preferred aspect, the present invention provides a process for enhancing the network security of an entity. The process comprises collecting network configuration and network environment information from network users, the information including the identification of suppliers of goods and services to the entity. In addition, the process preferably includes parsing the network configuration and network environment information to identify individual security risks associated with hardware devices, the network configuration, and the network environment comprising individual suppliers of goods and services and assigning a value to each security risk identified.

Further, in this aspect, the process preferably further comprises determining a cumulative security score for each user, including the values assigned to each security risk. In addition, in this aspect the present invention includes communicating the cumulative security score to each user.

Preferably, in this aspect, the process also includes offering the network users suggested changes to the network configuration including devices connected or connectable to the network, and/or changes to the network environment to each user to improve the cumulative security score.

Preferably, the process further comprises receiving at least one response from a network user to the suggested changes, and recalculating the cumulative security score based on the at least one response.

Preferably, in this process the entity is comprised of a plurality of sub-entities, each sub-entity including at least one network user, and preferably, the calculation of the cumulative security score is a function of the number of sub-entities. Preferably, each sub-entity has at least one attribute. Preferably, the process includes offering suggested changes to the network security configuration to at least one user. Preferably, the process further includes offering the suggested changes at a cost to each user. Preferably, the cost offered to each user is a function of the identity of the user.

In one particularly preferred present embodiment, the suggested changes include Stealth™ security services.

In another presently preferred embodiment, the present invention provides an incremental process for providing a secured network. In this embodiment, the process comprises assessing the configuration of an existing network, including users and devices and preferably identifying communities of interest employing the existing network. In this embodiment, the process also preferably includes defining a network security policy. In this embodiment, the process also preferably includes segmenting the existing network into client nodes, each client node being identified as belonging to at least one community of interest.

Further, in this embodiment, the process also preferably includes providing a security filter, consistent with the network securing policy, for each Network Access Control platform governing the existing network. In this embodiment, the process also preferably includes monitoring traffic, user behavior, and system processes on the existing network to detect unusual behavior associated with specific devices, users, or system processes, and isolating devices, users, or system processes manifesting the unusual behavior from the existing network.

Preferably, in this embodiment, the incremental process further comprises providing a centralized firewall for the existing network. Preferably, the incremental process further comprises providing public cloud hosting for internal services. Preferably, the incremental process optionally further comprises providing public cloud hosting for security services. Preferably, in this embodiment, the incremental process further comprises providing a primary secure server for the existing network. Preferably, in this embodiment, the incremental process further comprises identifying portions of the existing network servicing departmental business activities and providing secure servers for each such portion of the existing network.

Preferably, in this embodiment the security filter is derived at least in part from a real-time security assessment for each local and public network portion of the existing network.

Preferably, the process of the present invention further includes providing a real-time security assessment based on a machine learning process.

Preferably, the process of the present invention further includes providing a real-time security assessment that includes a numerical score reflective of the security risk, an optional set of security filter sets, and an optional set of commands to implement the security filter sets on each Network Access Control platform.

In yet another aspect, the present invention provides an incremental process for scaling the network security platform for all users. In this aspect, the process further includes collecting public network hosting providers for services, the information including the identification of supplier's goods and services creating sub-entities, scaling the hosting configuration for all users, the information including an automated, self-service, repeatable configuration including setup, operations, and support. Preferably, the process includes offering sub-entity services which can increase the user's security score.

In another aspect, the process provides for sharing network security of a user with another partner use. In this aspect, the process further includes defining a shared access network security policy; identifying communities of interest employing the shared network, defining a network security policy exchange process; and segmenting both networks into user and partner client nodes, each client node being identified as having a shared community of interest.

### DETAILED DESCRIPTION

The present invention provides an efficient process for secure network traffic. In one aspect, the process of the present invention provides Zero-Trust services to a network. In one aspect, the present invention provides a security score reflective of the quality of the implementation of Zero-Trust services. The more such Zero-Trust services a user implements, the higher the score, and by implementing these services, thus reducing or even eliminating the threat of theft or digital contamination.

Implementation of Zero-Trust requires all users, whether in or outside an organization's network, to be authenticated, authorized, and continuously validated for security configuration and posture before being granted or keeping access to applications and data. This security level can be implemented for a trusted network. However, there is no way to quickly quantify/score the security status of a non-trusted network and build the appropriate filter sets for each NAC provider. It would also take a dedicated team of people to build and keep the filter sets up to date. This implies that no threat level can be determined for each non-trusted access to company resources. Further, it would be prohibitively expensive and time consuming to maintain all the sundry filter sets required, even if the security status of a non-trusted network were to be evaluated only once.

As used in this specification and claims, “user” means a user of the process or game player” an “entity” is a hosting provider, a “sub-entity” means a service of the hosting provider, and a “UI” is a user interface for receiving user input.

In one embodiment, the present invention provides a process for quickly building accurate security filters for each Network Access Control (NAC platform) on a network by preferably employing artificial intelligence (AI). In one aspect, the present invention provides an API interface for an implementation of AI, such as ChatGPT. In one aspect, the interface provides a real-time assessment of the security level of a public or local network. In another aspect, the interface generates an appropriate filter set for an assessed network. In another aspect, the interface generates instructions (commands) for application of an appropriate filter set on each NAC platform on the network.

Artificial Intelligence (AI) refers to computer systems capable of performing tasks that historically required human intelligence. These tasks include recognizing speech, making decisions, and identifying patterns. AI encompasses various technologies, such as machine learning, deep learning, and natural language processing (NLP). Herein, the term “AI” is used to describe machine learning powered technologies like ChatGPT or computer vision.

In one aspect, the present invention employs AI to create both private and public filter sets for non-trusted networks as well as trusted logical overlay networks (e.g. Stealth™ SvLANs) from network scans. This allows for continuous adherence to security policy changes in any networking environment.

In one embodiment, the process of the present invention uses standardized REST API calls and aligns multiple independent platforms to apply the same organizational security policies (without constraints).

Exemplary non-trusted filter sets are based on the following Internet Assigned Numbers Authority (IANA) IP addressing criteria. IANA compliance ensures the uniqueness and efficient distribution of IP addresses, contributing to the smooth functioning of the internet. These filter sets provide private IP address services for the local non-trusted world. For example, a private IP address is used within a local network (such as your home or office network), which allows devices within the same network to communicate securely. These private IPs are not visible to the wider internet. Each device on the network is assigned a unique private IP address. These addresses are more secure because they remain hidden from external entities. Further, tracing of private IP addresses is possible only within the local network and cannot be seen online.

Another example is provided by public IP address services for the public non-trusted world. In this case, a public IP address is assigned by an internet service provider (ISP) and is used to communicate with devices outside the local network. This serves as the user's online identity and allows the user to interact with the broader internet. However, public IPs are visible to other devices on the internet, and can be traced back to reveal geographical locations, which can be useful for advertisers or hackers. Public IP addresses can be either dynamic (changing over time) or static (permanent). However, users can maintain anonymity while using the internet by employing methods like VPNs or the Tor Browser.

In one implementation, the present invention includes an AI API interface that defines and creates filter sets and returns a security assessment in the form of a Zero-Trust score for the subject network which includes a value and a brief security justification of the score, along with the configuration commands to the NAC provider, such as, for example, Unisys Stealth™, for enforcement.

In one aspect, in the local non-trusted world, the present invention employs AI to help define the local Access Control Lists. Local untrusted hosts are analyzed from Nmap scans, and a corporate policy is applied to those resources. The Nmap scan attributes are sent to an AI API, such as, for example, a ChatGPT API. The AI API provides a real-time security rating assessment score for each device, categorizes them into filter sets, and creates the filter commands, for administrative approval.

In another aspect, in the public non-trusted world, the present invention uses Al to help define the Software as a Service (SaaS) Access Control Lists. Public un-trusted IP addresses for each SaaS application from nslookup (“name server lookup”) to help find the active IP address ranges associated with a specific SaaS domain name for an application) scans (or equivalent DNS scanning tool) are analyzed along with published SaaS application IP address ranges that can be applied to a corporate policy. The present invention sends the nslookup scan attributes along with a request for known public IP address ranges for each SaaS platform to an AI platform through an AI API request. The AI API provides a real-time security rating assessment score for each SaaS platform, categorizes them into filter sets, and creates the filter commands for administrative approval.

Provided that AI can obtain the active public TCP/IP addresses for each SaaS provider (e.g., www.Office356.com), a repeating API request to AI would only have to score each SaaS provider and create (and update) NAC TCP/IP filter sets. If the SaaS score reaches a compromised threshold, the filter is revoked.

In this aspect of the present invention, the public SaaS filters provided by the present invention are universal and can be reused for other customers. However, since the SaaS application IP addresses are frequently updated (i.e. by maintenance or adding/deleting servers) the present invention preferably continually updates the SaaS filters.

In one aspect, the present invention includes loading a DNS service on the Zero-Trust platform of the present invention and tracking real-time DNS updates for all SaaS providers. This continuously maintains the SaaS filter sets through triggered DNS changes which creates updated ACL filters on the NAC platform.

Thus, the security assessment provided by the present invention becomes more granular with AI ratings and rankings for each filter set measured against continuously updated security criteria.

In the trusted world, the present invention can preferably use AI to create a “datacenter” by analyzing client server flows to make policies. The datacenters use captured network flow data (such as customer inventories, PCAP, NetFlow, IPFIX, sFlow or Nmap scans) supplied by the user from network devices that are parsed into network flow sets (i.e. server to server or client to server flows). The present invention preferably sends each flow set to the AI API to be categorized into a SvLAN (Scalable Virtual Local Area Network) and to create segmentation commands for administrative approval.

In this aspect, server communication flows follow a datacenter IPAM Schema (IP Address Management which includes server to server private IP ranges) so an application tiered system (web tier, application tier, and database tier) can use AI to block the communications from untrusted server endpoints. Client communication flows follow an IPAM IP Schema range for datacenter server to the client endpoints so trusted client to server communications can be categorized. This is an alternative to what is produced by a departmental tiered server segmentation wizard because all server traffic is restricted with AI policies. This means that client access preferably only needs to be configured for the process of the present invention and is granted through a DNAT (Destination Network Address Translation) at the datacenter edge (i.e., router, firewall, or load balancer).

In one aspect of the present invention, the process of the present invention deploys the Nmap utility to discover hosts on trusted local area network (LAN) segments. In one aspect, the process application prompts the administrator for trusted client and server TCP/IP subnet networks, creates filter sets from the Nmap remote sensor. The process of the present invention calls the Nmap utility to output discovered host information (open ports and services) to a text file. Two scans will be performed to differentiate between client and server subnets. The process of the present invention then imports the text file to categorize the hosts and creates clear text filter sets with AI. In an alternative to AI, scans are compared to an existing database of approved access control lists (ACLs). The administrator then identifies required filter sets and applies the filter to the appropriate client or server SvLAN or role.

In another aspect, the process of the present invention deploys the Nmap remote sensor on the user's site to discover all the endpoints on the respective local networks. The process of the present invention remotely runs the Nmap script to discover all the endpoints for the discovery inventory and send to AI to create the filter sets.

Since AI uses natural language processing (NLP), natural language can be used to formulate AI queries. The AI API can send queries to the AI and obtain important information about the network being queried. These queries include assigning filter sets, making a security assessment (with all the Nmap information) to provide a value, such as in the range 1-100, and/or whether the target network had been recently hacked and/or whether active TCP/IP addresses can be validated from ARIN. The Nmap utility provides a lot of local traffic information. However, network traffic files like PCAP, NetFlow, IPFIX, and sFlow scans can be imported by the process of the present invention and the scans sent to the AI to help build the datacenter.

The AI interface provides a security assessment score (with brief justification about the security risk), assigned filter sets for administrative approval, and commands to execute the restrictions for each NAC platform.

In one aspect, the process of the present invention employs the Nmap remote sensor for an initial equipment inventory and filter creation, and preferably remains in continuing use to account for real-time filter changes when DHCP addresses expire, or endpoints are added or removed from the network.

Another aspect of the process of the present invention employs the sensor as an intrusion detection system to immediately notify the network administrator when something new is added to the network.

In another aspect, the process of the present invention employs AI to build local network inventories and CT filter lists. The process preferably logs Nmap attribute information for each endpoint into a central database. The process preferably also creates unique individual endpoint entries by hashing the endpoints MAC and IP address. The hash will lock down the device and location (preventing MAC address spoofing) and can be used to quickly determine if the rule has already been created by comparing new hash entries to the old scans. Clear text rules can be validated, modified, or deleted after each scan to keep the security access current.

In one aspect, the present invention employs an Nmap sensor using AI to build local trusted network inventories and SvLAN segments. The Nmap sensor can scan local trusted servers since they share a common community of interest (i.e., an Nmap COI crypto key). Server naming conventions preferably help determine their exact role, but only if the customer has their function and department built into their naming convention. Otherwise, other Nmap information can help AI determine the role as well as importing client inventories to aide in the classification process. Thus, all the server endpoints will preferably have a common COI crypto key with the Nmap local trusted network sensor. The process of the present invention preferably logs Nmap attribute information for each endpoint into a central database.

In one aspect of the present invention, information concerning the status of the process is displayed to the administrator implementing the process. Information displayed preferably includes standard solutions that are automatically created as part of the process implementation. These standard solutions include whitelist firewall SvLANs that allow for exceptions and internet connectivity options. These standard whitelist solutions preferably include whitelists for intranet, infrastructure, global, internet, and proxies. Whitelists typically include individuals, sites, and/or networks allowing access to clients, or allowing access for clients.

In practice, the whitelist is an ACL that allows access to identify known secure IP addresses while blocking access to everything else. Whitelisting is used to help prevent malware attacks on networks. An administrator (network, system, or firewall) can configure a whitelist by adding node IP addresses to one of the standard solution profiles preferably provided by the process of the present invention, which limits the sites accessible to users.

Conversely, blacklists are used by network administrators to deny access to services of previously identified threats to clients such as sites that try to add spyware to their computer. Since the blacklist allows access to everything else, there is the risk that any unidentified threat (i.e., zero-day attacks) can infiltrate a computer and take over the network. Blacklists are often used on external firewalls but are also available by adding suspicious server IP addresses to a restricted profile in an internet policy.

Many companies prefer to deny all traffic and permit only necessary communication flows by using a security model known as Deny All Permit Exception (DAPE). All organizational and functional solutions are DAPE compliant and provide a more secure security posture than using either whitelists or blacklists. If a user chooses a standard solution, a prior default solution is used (excluding the internet profile), communication is only permitted access to sites or applications known to be secure, making a client computer (and network) more secure. However, whitelisting standard solution SvLANs is very labor-intensive because the whitelist must be updated whenever the communication does not fit the existing set of rules, or a new policy must be created to allow communication for new sites.

In one aspect, the process of the present invention provides SvLANs for enterprise service management (ESM) (“Tier 0 services”). Here, the isolation and security controls provided by the process of the present invention are employed to restrict ESM tools. These platforms typically include infrastructure IT services that an enterprise would typically provide such as network monitoring, security information and event management (SIEM), device inventory\management, identity access management, software distribution and deployment, DNS, and malware/anti-virus. Preferably, the process of the present invention provides least privilege access from these platforms to enterprise desktops and servers, thus providing a secure management network that isolates ESM services with specific controls down to the IP address, port, and protocol. This reduces the risk exposure and data exfiltration even if compromised by malware since the malware cannot contact command and control.

The present invention preferably provides an environment with a SvLAN specifically adapted for the ESM servers. The policy so provided locks down communications (ports and protocols) and flows (directional COIs) to their destinations. ESM applications and platforms are essential for business function. Failing to restrict access to these applications and platforms using a Zero-Trust paradigm could result in critical business applications being sabotaged and data exfiltration, loss of revenue, damage to brand image, and distrust among clients.

The present invention also preferably provides internal supplier policy management for non-trusted local networks. This policy is preferably added to profiles and nodes that are part of the internal network that are to be whitelisted. The address space (that is, the range of IP addresses in the private range) is predefined and cannot be modified.

Secured intranet IP address management (IPAM) is the administration of TCP/IP addresses that are assigned to nodes (manually or by DHCP) and used by DNS to deliver network services. In other words, IPAM is a means of planning, tracking, and managing the intranet protocol address space used in a network. Most commonly, tools such as DNS and DHCP are used in tandem to perform this task, though true IPAM will link these services together so that each is aware of changes in the other. For instance, DNS is kept up to date when an IP address is taken by a client via DHCP (and updating itself accordingly) but is transparent when providing security services.

The process of the present invention preferably provides visibility into the security policy of each IP address through assigned profiles and security SvLANs. Each IPAM profile will preferably show unused IP addresses and will preferably also generate an alert when assigning duplicate IP addresses to other profiles.

IPAM policy with the intranet IPAM profiles is a special whitelist that contains all intranet (or internal) IP addresses. The IPAM profile is typically added to an intranet IPAM policy so IP addresses from the intranet range can be assigned to other profiles. These profiles are containers (i.e., summary IP ranges, subnets, or nodes) and preferably do not have any channel connections. The IP address assignment to other profiles is preferably automatically deducted from the IPAM solution IP address range. Preferably, a pop-up message to the process administrator will confirm the removal of the IP address from the IPAM profile thus preventing duplicate IP address assignments in the network.

In one aspect of the process of the present invention, a server only configuration uses a special intranet IPAM profile to strictly enforce security SvLANs only to servers configured according to the process of the present invention. The result is a client profile that can access such servers and CT servers without complex network filters.

Preferably, the process of the present invention also optionally provides profiles for unsupported servers, which allows clients and servers to access servers that are unable to load a suitable driver. Similarly, the process of the present invention also optionally provides support for unlicensed servers, which allows licensed clients and servers to access servers that are not licensed. Similarly, the process of the present invention also optionally provides support for unlicensed clients, which allows unlicensed clients to access servers carrying out the process of the present invention (“enabled servers”). While these profiles allow for unsecured devices to access enabled devices, and uses existing protection and perimeter firewall models, they assume a risk associated with existing client endpoint and perimeter firewall protection against compromised servers.

In another aspect, the process of the present invention optionally provides internal supplier policy management (“AI infrastructure services”). This policy permits adding whitelists for internal network infrastructure services. In these cases, the systems will be whitelisted for the enabled network. Infrastructure devices are the components of a network that transport communications needed for data, applications, services, and multi-media.

These devices are ideal targets for malicious cyber actors because most or all organizational and customer traffic must pass through them. An attacker with access to an organization's router can monitor, modify, and deny traffic to and from the organization. Once compromised, an attacker has access to an organization's internal routing and switching infrastructure and can monitor, modify, and deny traffic to and from key hosts inside the network and leverage trust relationships to conduct lateral movement to other hosts. Organizations that use legacy, unencrypted protocols to manage firewalls, routers, and switches, make successful credential harvesting easy for malicious cyber attackers. Whoever controls the routing infrastructure of a network essentially controls the data flowing through the network. The process of the present invention mitigates these risks by securing least privilege access to critical infrastructure.

Preferably, to increase the real-time effectiveness in the local non-trusted network world, the process of the present invention employs an Nmap sensor with AI to help define the local access control lists and score the filter set.

In another aspect, the process of the present invention preferably provides profiles for supplier whitelists. Examples of such profiles include profiles for Active Directory Servers, Domain Name Server Resolution, Load Balancers, VoIP PBXs, Routers, Switches, Network Attached Storage (NAS), VDI Policies, Cell Phones or Tablets, Windows Clients, Digital Signage/Content Streaming, Surveillance Cameras, Security Alarm Systems, Print Servers, Firewalls, Intrusion Detection/Prevention, Multimedia, ESM Tools, Internet of Things (IoT)/Operational Technology (OT) devices, other network headless devices like Amazon Alexa, thermostats, etc.

In another aspect, the present invention provides for policy management for external suppliers, such as non-trusted public networks, including Software as a Service (SaaS) and Kubernetes. Cloud computing is a web-based services access which allows businesses and individuals to consume computing resources such as virtual machines, databases, processing, memory, services (e.g., Kubernetes), storage, messaging, events, and pay-as-you-go. In this aspect, the process of the present invention allows a firewall policy to be applied to the common cloud computing service platforms that are not controlled by the user.

Frequently, enterprise users require access to common cloud platforms and want a single security policy applied to the enterprise for both internal and external services. Many enterprises leverage external cloud service providers as well as the plethora of services they offer. Since these cloud services are not managed by the enterprise and are accessed using publicly facing IP addresses, securing traffic between enabled enterprise resources and these external cloud services can require special attention. The process of the present invention allows enterprise users to create an essential SaaS policy that has profiles for every relevant cloud service provider. Preferably, each profile will have nodes populated with the IP address ranges required to access each service. The IP address ranges are available from the service provider and/or use American Registry of Internet Numbers (ARIN) to validate ranges.

In one aspect of the present invention, effective profiles require that each cloud service provider use suitable authentication and authorization controls for each service as well as TLS encryption, so the overall security posture is not compromised. Preferably, to increase the real-time effectiveness in the public non-trusted network world, the Nslookup utility along with AI is used to define the SaaS access control lists and score the filter set.

In one aspect, the present invention provides a special whitelist profile (“internet profile”) that contains all public IP addresses excluding the essential SaaS policy IP addresses and restricted websites. This profile is typically connected to the Proxy Policy so a web browsing security policy can be applied to enabled client profiles. If an inline web content filter is being used, enabled client profiles can be connected directly to the internet profile.

In another aspect, the process of the present invention provides a restricted profile (with no channel connections) containing a list of suspicious or malicious IP addresses that will be blacklisted and denied access to the enabled network.

In one embodiment of the process of the present invention, the process is structured as a game intended to make individuals with responsibility for improving the security of a network familiar with Zero-Trust principles and qualified to implement the process of the present invention on their own “trusted” networks. In this embodiment, the network is identified as the “homestead” to be protected against external threats (“outlaws”) who seek to breach the network. As the game progresses, a Zero-Trust security score for the network is computed. The game player builds the network by adding “residents” (employees and server pairs) or entire organizations which are protected by one or more security measures as they are added. The game player must choose each of the security measures for each added resident. As each resident is added, the security score is incremented. The security score reflects the value of the security measures provided for each new resident. Since a new homestead requires, not only homesteaders, but also supplies from various sources to build the homestead, the game permits the player to add “suppliers” for the homestead, corresponding to permitting access to the network by third parties, by the addition of each such “untrusted” network. Game play continues until the trusted network is complete, or the network is breached by an “outlaw” (e.g. a hacker). While the game progresses, security threats are generated to challenge the security measures protecting the homestead.

In one version of the present invention, the game player must choose and “pay” for the security measures implemented for each resident. In this version, the cost of each security measure may reflect the difficulty of implementing the security measure on a physical network. Since a specific “target” network can be implemented with different security measures, the value of a specific set of security measures implemented on a target network can be compared with the security score, permitting different approaches to providing a Zero-Trust network to be evaluated.

Preferably, the game provides many opportunities to win prizes such as for achieving the highest security score and the lowest number of vulnerabilities. The prizes can represent the user's cost savings from security threats and reductions in operating expenses.

Preferably, the process of the present invention also provides achievement milestones calculated from a user's game history, such as corporate compliancy with standards established by regulatory authorities, network independence, optimization of support, network and security hardware optimization, Zero-Trust deployment configuration, datacenter edge optimization.

The score is assigned to specific aspects of the process of evaluating the security risks associated with each aspect of a user's specific network configuration. The score is based on values assigned to assets considered to enhance network security as well as values assigned to risks, such as by connections to the networks of third parties, such as suppliers. Such values can be assigned by a subjective evaluation of each asset based on experience or assets of a similar type, or by an objective evaluation.

An example of the values assigned, in the specific case in which the process of the present invention is employed to secure a datacenter edge is:
Homestead Pieces:

| | |
|---|---|
| Packet Inspection | +$100 |
| Provide Next-Generation Firewall (NGFW) | +$100 |
| Provide WAF to secure SSL/TLS connections | +$100 |
| Threat Intelligence (IDS/IPS) | +$100 |
| Server Health Checks and Monitoring | +$50 |
| Provides overlay network client passthrough | +$50 |
| Single Sign On (SSO) with common AD groups | +$100 |
| Provides advanced logging and reporting | +$100 |
| (in conjunction with endpoint isolation) | |

In a presently preferred embodiment, the process of the present invention is implemented as an application using the Stealth™ platform provided by the Unisys Corporation for use by a system administrator. Initially, the administrator inputs customer data into the application which generates Stealth™ ECO API commands to configure the Stealth™ platform to set up a Zero-Trust “game board.” The customer data is derived from the existing customer network and includes information about physical assets such as servers and client computers (“devices”) as well as existing network users.

Using Stealth™, the administrator creates a universe of “endpoints,” which are devices or systems protected by a Stealth™ “agent” (“Stealth™ enabled” or simply “enabled’). The endpoints are grouped into “communities of interest” in which the endpoints are cryptographically separated such that they can only communicate with each other. Membership in each community of interest is provided by assigning users and groups of users to “roles”. The endpoints are “configured” by specifying the authorization methods and services required for a user or group of users to join a community of interest. Filters constrain communication between endpoints to specific addresses, protocols and ports, and permit access to non-enabled devices or systems (“clear text filters”).

The application also generates a Zero-Trust security score as well as a metric tracking the total cost of the Zero-Trust.

Using the application, the administrator manually adds SvLANs (scalable virtual local area networks) to the “game board” and clear text filters. The application employs an Nmap utility to discover local endpoints and to prepopulate clear text filter sets for assignment existing network assets to SvLANs and user roles.

In one aspect of the process of the present invention, the Nmap utility is deployed to discover hosts on trusted network segments. The application prompts the administrator for trusted TCP/IP networks and calls the Nmap utility to output discovered host information (open ports and services) to a text file. The text file is then imported into the application to categorize the hosts and create clear text filter sets. The administrator then identifies required filter sets and applies the filter to the appropriate client or server SvLAN or role. The Nmap utility is employed to scan, discover, and gather information, about network hosts and services and will be imported into the application. The application assigns a clear text filter set to every node from the scan. The application uses Nmap output scan (including host name, endpoints IP address, and open ports) to create the clear text filter sets for, for example, printers, routers, switches, cameras, IoT objects, and the like. The application adds discovered workstation and server operating systems to unlicensed clear text filter sets. The administrator assigns the clear text filter sets to each residential SvLAN and role. Enabled clients and servers will not be discovered with Nmap since they are cloaked on the network. The Nmap remote sensor is deployed on the customer's site to discover all the endpoints on their internal networks. The application then remotely runs the Nmap script to discover all the endpoints for the clear text filters. The Nmap remote sensor is preferably used for the initial Clear Text Filter creation and preferably is left in place to account for real-time filter changes when DHCP addresses expire or endpoints are added or removed from the network. The application preferably logs Nmap attribute information for each endpoint into a central database. The application preferably creates unique individual endpoint entries by hashing the endpoints MAC and IP address. The hash created can be used to quickly determine if the rule has already been created by comparing new hash entries to the old scans. The clear text rules can then be validated, modified, or deleted after each scan to keep the security access current.

The application applying the process of the present invention will preferably provide a security score reflecting the underlying structure of the network being secured and the Zero-Trust measures being chosen to be implemented by the administrator. The security score is intended to guide the administrator in weighing the security value of alternative network configurations and alternative security measures to be provided.

The calculation of a security score is provided in the following example.
Homestead Values:

| | |
|---|---|
| SvLANs (from client's organization chart) | +$100/SvLAN |
| Directional COIs (i.e., private SvLANs) | +$20 |
| Application Microsegmentation (i.e., firewall rules) | +$20 |
| Dynamic Isolation | +$100 |
| Proxy Servers | +$100 |
| Suppliers Values | −$5/Vulnerability |

Vulnerability:
   Clear text filters for Internal Infrastructure Suppliers
   Active Directory Servers
   Domain Name Server Resolution
   Non-enabled Load Balancer (Stealth™ only supports layer 3)
   VoIP PBXs
   Routers
   Switches
   Network Attached Storage (NAS)
   Non-enabled VDI Policies
   Digital Signage/Content Streaming
   Surveillance Cameras
   Security Alarm Systems
   Print Servers
   Firewalls
   Intrusion Detection/Prevention
   Multimedia
   Non-enabled ESM Tools
   Other network appliances and non-enabled servers
Customer clear text filters for external Software as a Service −$10
Vulnerability:
Clear text filters for Internal Infrastructure
Suppliers
Salesforce
Microsoft
Adobe Creative Cloud
FreshBooks
Paychex
Google Workspace
Xero
Zendesk
RingCentral
Plus, 100s more . . .
Approved Clear Text Filters for External SaaS Suppliers +$10/Vulnerability.
Salesforce
Microsoft
Adobe Creative Cloud
FreshBooks
Paychex
Google Workspace
Xero
Zendesk
RingCentral
Plus, 100s more . . .

Applying the vulnerability values to a specific customer network, the security score can be calculated as follows:

| Security Model | | SvLAN\Role\ | |
|---|---|---|---|
| Worksheet | Value | Whitelist | Total |
| Dynamic Isolation | $100 | 1 | $100 |
| Server VLAN\Role | $100 | 3 | $300 |
| (Including Tiered | | | |
| VLANs) | | | |
| Client VLAN\Role | $100 | 4 | $400 |
| Direction COI | $20 | 3 | $60 |
| Application Micro | $20 | 0 | $0 |
| segmentation (IP | | | |
| Address\Port\Protocol) | | | |
| Internet Proxy Server | $100 | 1 | $100 |
| Trusted Server | −$5 | 3 | −$15 |
| Whitelist | | | |
| Trusted Client | $5 | 8 | −$40 |
| Whitelist - | | | |
| Untrusted Client | −$10 | 12 | −$120 |
| Whitelist | | | |
| Untrusted Server | −$10 | 0 | $0 |
| Whitelist | | | |

| | |
|---|---|
| Total Recurring Costs/Month | $1,135 |
| Complexity Rating | Medium |
| Stealth ™ Security Costs/Month | $960 |
| Vulnerability Costs/Month | −$175 |
| Zero-Trust “Efficiency” | 85% |

The process of the present invention is intended to extend throughout the entire digital landscape and to serve as an integrated security philosophy and end-to-end strategy. This is done by implementing Zero-Trust controls and technologies across six foundational elements: identities, devices, applications, data, infrastructure, and networks. Each of these six foundational elements is a source of signal, a control plane for enforcement, and a critical resource to be defended. This makes each an important area to focus on financial investment versus security.

Identities, whether they represent people, services, or IOT devices, define the Zero-Trust control plane. When an identity attempts to access a resource, the process of the present invention verifies that identity with strong authentication, ensures access is compliant and typical for that identity, and follows least privilege access principles.

When the process of the present invention is employed to evaluate the security of networks with Identity Access Management (IAM), Federate, and Score Single Sign-On, of major Internet Identity providers (IdP) the IAM r options can be scored as follows:

Scoring Identity Access Management (AIM) for Microsoft and LINUX

| | | Filter, | | | |
|---|---|---|---|---|---|
| | Gaming | Protocol, | IAM | | |
| IAM Options | Score | or Service | Platform | Description | Definition |
| Active Directory | n/a | Service | Microsoft | IAM built for | Identity and Access |
| (AD) | | | | Windows | Management (IAM) is a |
| | | | | endpoints | platform that helps securely |
| okta | n/a | Service | LINUX | IAM built for | control access to a variety of |
| | | | | LINUX | cloud and on-premises |
| | | | | endpoints | applications. |
| MFA | $100 | Service | Both | A mechanism | The core objective of IAM |
| | | | | requiring | systems is to have one digital |
| | | | | additional | identity per individual or |
| | | | | verification | device. |
| | | | | beyond a | Once the digital identity has |
| | | | | password | been established, it must be |
| LDAP | $100 | Protocol | Both | Used for | maintained, modified, and |
| | | | | querying and | monitored throughout each |
| | | | | managing | user's (or device's) access |
| | | | | directories | lifecycle or the security policy |
| SAML | $100 | Protocol* | Both | SSO for | will be compromised. |
| | | | | internal | |
| | | | | identity to | |
| | | | | access | |
| | | | | multiple | |
| | | | | external | |
| | | | | service | |
| | | | | providers | |
| OpenID | $100 | Protocol* | Both | SSO for | |
| | | | | external | |
| | | | | identity to | |
| | | | | access | |
| | | | | corporate | |
| | | | | externally | |
| | | | | hosted | |
| | | | | services | |
| Oauth | $100 | Protocol* | Both | Internal | |
| | | | | delegation of | |
| | | | | external | |
| | | | | application | |
| | | | | to access to | |
| | | | | another user | |

*Enhanced HTTPS

Once an identity has been granted access to a resource, data can flow to a variety of different devices, from loT devices to smartphones, BYOD to partner managed devices, and on-premises workloads to cloud hosted servers. This diversity creates multiple attack surface areas, required to monitor and enforce device health and compliance for secure access.

Applications and APIs provide the interface by which data is consumed. They may be legacy on-premises, lift-and-shifted to cloud workloads, or modern SaaS applications. Controls and technologies are applied to discover Shadow IT, ensure appropriate in-app permissions, gate access based on real-time analytics, monitor for abnormal behavior, control of user actions, and validate secure configuration options.

Ultimately, security teams are focused on protecting data. Where possible, data should remain safe even if it leaves the devices, apps, infrastructure, and networks the organization controls. Data should be classified, labeled, and encrypted, and access restricted based on those attributes.

Infrastructure (whether on-premises servers, cloud-based VMs, containers, or micro-services) represents a critical threat vector. Such infrastructure should be assessed for version, configuration, and Just in Time (JIT) access to harden defense, and Intrusion Detection/Protection platforms should be employed to detect attacks.

All data is ultimately accessed over network infrastructure. The process of the present invention controls can provide critical information to enhance visibility and help prevent attackers from moving laterally across the network. Networks should be segmented (including microsegmentation) and real-time threat protection, end-to-end encryption, monitoring, and analytics can be deployed.

In an implementation of the present invention the digital landscape is connected and able to manage security threats by making informed access decisions using automated policy enforcement.

The major components of such an implementation are:
An Identity Management System, exemplified by Active Directory, LDAP, and Certificates;
A Network Access Control (NAC) provider, exemplified by Unisys Stealth™, Aruba ClearPass, Cisco Identity Services Engine (ISE), Extreme Networks Extreme Control, Forescout Platform, Fortinet FortiNAC, and InfoExpress CyberGatekeeper;
A Zero-Trust policy manager implementing the process of the present invention;
A Secured Datacenter Edge (Secure Access Service Edge), exemplified by Load Balancers similar to NGINX Plus, F5, and e-mail SMTP\IMAP security scanners;
Client Proxy Services, exemplified by web proxies and content filters similar to NGINX Plus Proxy, Squid Proxy.

These major components of the Zero-Trust model can work together to deliver end-to-end security coverage.

The present invention preferably provides the ability to manage security threats by making informed access decisions using automated policy enforcement.

In a presently preferred implementation of the process of the present invention, the implementation includes as components an identity management system, such as for example, Active Directory, LDAP, and Certificates, a Network Access Control (NAC) system such as Stealth™, Aruba ClearPass, Cisco Identity Services Engine (ISE), Extreme Networks Extreme Control, Forescout Platform, Fortinet FortiNAC, and InfoExpress CyberGatekeeper, a Zero-Trust policy manager implementing the process of the present invention, a secured datacenter edge (Secure Access Service Edge) such as load balancers similar to NGINX Plus, F5, and email SMTP\MAP security scanners, client proxy services such as web proxies and Content filters similar to NGINX Plus Proxy, Squid Proxy.

Modern companies have outgrown traditional network security technologies and have moved to subscription services. Previously, a company would have to buy and manage all their network infrastructure to gain the highest levels of security. The process of the present invention provides a policy manager that requires a Network Access Control (NAC) platform to define and implement access rules (using standard network protocols for policy enforcement). NAC solutions can help organizations ensure that only authorized users and devices are granted access to the network. NAC products can also help organizations identify and remediate security threats by monitoring network traffic and enforcing security policies. The process of the present invention can be implemented on any NAC platform, as it uses standard REST API calls to supply commands to enforce least privilege access policies to the NAC provider. The primary requirements for the NAC provider are to tag user groups and server groups, allow or deny access to the groups, and allow firewall filters for each group. The NAC provider can use many networking technologies including enabled SvLANs, traditional VLANs, or Security Group Tagging (SGT), to enforce segmentation.

Since the process of the present invention is network independent, security features may be enhanced or limited depending on the NAC provider. For example, some providers may not be capable of enforcing encrypted communication to trusted endpoints, provide in-line security threat detection, or firewall protection from suppliers. The process of the present invention preferably uses its own network protocol (SCIP) to authorize users and does not have dependencies on equipment ownership for security enforcement.

NAC providers can also utilize Zero-Trust policies as implemented by the process of the present invention to secure the endpoint to the network switch port (PNAC\802. 1x\Cisco SGT) utilizing the REST API, but it is not true end-to-end security. Representative NAC providers include Unisys (Stealth™), Aruba ClearPass, Cisco Identity Services Engine (ISE), Extreme Networks—Extreme Control, Forescout Platform, Fortinet FortiNAC, and InfoExpress CyberGatekeeper. Some of these entities provide end-to-end encryption enforcement, policy enforcement, API scripting and programming. Preferably, the NAC platform uses the RADIUS protocol to provide authentication, authorization, and accounting (AAA) and encrypts all communication between the RADIUS server and the client device. Preferably, the NAC platform uses Transport Layer Security (TLS) to encrypt communication between the controller server and other network devices. However, network traffic may still be routed through the organization's routers and switches which may or may not use encryption.

The lower the authorization to critical resources in the OSI Model (the OSI Model has seven layers) results in a more secure communication. Stealth™ employs level 2. REST stands for Representational State Transfer. A REST API is one such common interface where API calls are made using HTTP requests and can be used to expand the platform.

The process of the present invention implemented with Stealth™ provides the rules of least privilege networking that is independent of physical hardware. After the game setup, users will circle the wagon train with a policy manager implementing the present process (“Zero-Trust Policy manager”) and NAC enforcement platform to defend their network (“Homestead.”) The results will educate the user, protect their assets, and highlight the deficiencies of their network security implementation.

The process of the present invention is preferably implemented using a standards-based, software-defined, identity managed, and endpoint segmentation security policy, suitable for limited tactical and large enterprise-wide deployment, irrespective of the existing physical network topology. Preferably, the process of the present invention is implemented to provide the ability to microsegment, encrypt traffic, obfuscate from adversaries, and remediate threats throughout an enterprise.

Preferably, the process of the present invention provides overlay networks which are cryptographically separated from the underlying infrastructure and each other and provide its functions regardless of who controls or manages the underlying infrastructure. Preferably, the overlay network is a logical overlay network that groups together a subset of devices that do not share a physical LAN, isolating the traffic for each group. Since these overlay networks are network independent, residential segmentation is possible anywhere on the internet.

In one aspect, the process of the present invention promotes residential segmentation (i.e., Zero-Trust) of a user's network through endpoint isolation (Stealth™_ implemented dynamic isolation) and by applying overlay networks reflecting business logic segmentation to common least privilege security groups (e.g. accounting, human resources, legal, shipping, etc.) assigned to residential client/server applications. These directional COIs reduce malware attacks since clients cannot propagate the malware to other residential servers and clients.

In another aspect, the process of the present invention promotes application segmentation (e.g. Stealth™ microsegmentation) which provides individual intra-residential client/server segmentation polices based on IP address, port, protocol, and directional communication flows.

The process of the present invention can be applied to on-premises, multi-site, public, private, and hybrid cloud environments. One common security policy can be defined to span a user's entire operating environment.

Preferably, the process of the present invention has a security policy which includes as its components: Role (an overlay network assigned to a user's residential client/server pairs; COI (a cryptographic key assigned to a Role to allow access to other overlay networks); Filter (a whitelist firewall assigned to each Role (or to microsegment a non-Stealth™ application)); Identity (a residential group (AD, LDAP, or Certificates) assigned to each Role).

In one aspect, the process of the present invention, employed with a secured datacenter edge allows transparent access between the application residents (in remote datacenters) and roaming user residents (throughout the internet). The objective is to provide minimum access to the network edge for confidential data on internal servers or in the cloud. Preferably, the process of the present invention provides security controls which will adapt to every change in the environment as companies grow organically or through acquisition. Preferably, in the process of the present invention when users are assigned residential access controls to the Homestead, it will follow them everywhere.

In implementing network segmentation, the process of the present invention can be structured to reflect the goals of the overlay network being applied. For example, a primary Stealth™ overlay network can be used to Stealth™-enable traditional enterprise applications and clients, by providing protection for external cyber threats in corporate networks through reducing (or eliminating) external attack surfaces by using Stealth™ to enforce least privilege access to corporate resources. A single client/server overlay network is provided for a client to prevent external attacks.

In another aspect, the process of the present invention can be structured to promote network isolation and security controls based on strategic business units (i.e., Manufacturing, HR, Marketing, Finance/Accounting, and Development). In this case, the user desires to implement “least privilege” access to employees and restrict access to Personal Identifiable Information (PII) and Intellectual Property (IP) data, by building secure networks that are logically divided into smaller, isolated networks with specific membership (access rights). Such isolated networks prevent network users from accessing business applications that do not support their role which could open the door to overexposure of critical company data and which would otherwise make it easier for bad attackers to move throughout your network and exfiltrate such data once they have penetrated the network of your perimeter security. The present process can be structured to create overlay networks for each business dedicated environment (or process) and restrict access to least privilege.

Similarly, the process of the present invention can be structured for other types of data environments. For example, the process can be structured to help secure networks permitting access to classified information, or to confidential personal data such as medical records or the like for which access is subject to government regulation, or to central datastores containing financial information, etc.

In another aspect of the present invention, the security score of a target network being evaluated by the process can be enhanced if the network can exchange tokens (COIs) with another similarly protected network of a trusted third party.

The Community Store is a relational database that permits Stealth users to gain secure access to Stealth Partner networks. Utilizing the Stealth Import\Export function, the Community Store will store Stealth keys that will be shared between Stealth enclaves. The Community Store will authenticate the owner and partner before sharing the Stealth keys.

Each key will be assigned or revoked by the owner or the partner. The Community Store is also used to scale the Stealth Platform past its current user limits by increasing the capacity well beyond a single instance.

The process to exchange tokens (COIs) with trusted third parties in the same Gaming-Zero Trust echo system (i.e. Community store and Dell Cloud).

After the token has been exchanged, the user and the third party can delegate the appropriate permissions and revocation.

The Community Store can be used to expand the platform for partners and scale the Gaming-Zero echo system to support increased capacity.

Scoring values can be quantitative based on data representative of actual identified security breaches, or qualitative, based on the judgment of experienced security professionals; Examples of scoring for various situations in which Zero Trust principles can be applied are given below:

Scoring Network Access Control (NAC)

| | | Filter, | | | |
|---|---|---|---|---|---|
| | Gaming | Protocol, | | | |
| NAC Options | Score | or Service | Platform | Description | Definition |
| Group Isolation (i.e., VLANs)\ | $100 | Service | NAC | Segmentation/ | NAC solutions |
| Segmentation | | | | VLANs | help organizations |
| Private Groups (i.e., directional | $20 | Service | NAC | Private | ensure that only |
| communication) | | | | VLANS or | authorized users |
| | | | | Directional | and devices are |
| | | | | COIs | granted access to |
| Network Encryption | $100 | Service | NAC | Encryption | the network. |
| | | | | in transit | NAC products |
| Internal Firewall Filters per | $5 | Filter | NMAP | Firewall | also help |
| Group* | | | | Filters | organizations |
| External Firewall Filters per | $10 | Filter | NAC | Firewall | identify and |
| Group* | | | | Filters | remediate security |
| Dynamic Isolation | $100 | Service | NAC | Removal of | threats by |
| | | | | compromised | monitoring |
| | | | | endpoints | network traffic and |
| Endpoint security interrogation\ | $100 | Service | NMAP | Local | enforcing security |
| Software version control | | | NAC | Network | policies. NAC is |
| | | | | Scanning | built into the |
| | | | | Tool/NAC | Gaming Zero- |
| Internet Proxy Server | $100 | Service | Proxy | Centralized | Trust application |
| | | | Server | Internet | and is capable of |
| | | | | Content | being ported to |
| | | | | Filtering | any NAC platform. |
| | | | | | *AI will score the |
| | | | | | risk for each |
| | | | | | Internal and |
| | | | | | External Filter |
| | | | | | sets. Along with |
| | | | | | the assessment, it |
| | | | | | will provide a |
| | | | | | security |
| | | | | | justification (with |
| | | | | | sources), and |
| | | | | | create a script to |
| | | | | | the NAC to |
| | | | | | execute the filters. |

Scoring the Secure Access Service Edge (SASE)

| | | Filter, | | | |
|---|---|---|---|---|---|
| | Gaming | Protocol, | | | |
| SASE Options | Score | or Service | Platform | Description | Definition |
| Packet Inspection | $100 | Service | SASE | Packet | Edge security is a |
| | | | | Payload | type of enterprise |
| | | | | Analysis | security for |
| Provide Next-generation firewall | $100 | Service | SASE | Advanced | corporate |
| (NGFW) | | | | Firewall | resources that are |
| | | | | Protection | no longer located |
| | | | | for all | within the |
| | | | | threats | protective |
| Domain Name Service | $100 | Service | SASE | DNS-Layer | boundaries of a |
| | | | | Security | centralized |
| | | | | protection | datacenter. |
| Provide WAF to secure | $100 | Service | SASE | Advanced | It's used to protect |
| SSL/TLS connections | | | | Firewall | users and |
| | | | | Protection | applications at the |
| | | | | for Web | farthest reaches, |
| | | | | threats | or “edge,” of a |
| Threat Intelligence (IDS/IPS) | $100 | Service | SASE | Detects | company's |
| | | | | Network | network, where |
| | | | | anomalies | sensitive data is |
| Server Health Checks and | $100 | Service | SASE | Monitoring | highly vulnerable |
| Monitoring | | | | and removal | to security threats. |
| | | | | of non- | Common Edge |
| | | | | functioning | devices include |
| | | | | or infected | routers, firewalls, |
| | | | | servers | and load |
| Provides Stealth client | $100 | Service | SASE | Provides | balancers. |
| passthrough | | | | fast packet | |
| | | | | switching | |
| | | | | on the | |
| | | | | SASE, but | |
| | | | | disables | |
| | | | | packet | |
| | | | | inspection | |
| Single Sign On (SSO) with | $100 | Service | IAM | Eliminates | |
| common Groups | | | | the threat | |
| | | | | of password | |
| | | | | theft | |

Scoring Sponsored Terrorism TCP/IP Subnet Filters (by Country):
Top 10 International Untrusted\Blacklisted Vulnerabilities

| | | Filter, | | | |
|---|---|---|---|---|---|
| | Gaming | Protocol, | | | |
| Filter Options | Score | or Service | Platform | Description | Definition |
| 1. China | $50 | Filter | NAC | Risky | Sponsored |
| | | | | Filters | Terrorism or risky |
| 2. Myanmar | $50 | Filter | NAC | Risky | TCP/IP Filters will |
| | | | | Filters | be flagged with a |
| 3. Iran | $50 | Filter | NAC | Risky | high gaming zero- |
| | | | | Filters | trust score. AI will |
| 4. Cuba | $50 | Filter | NAC | Risky | be used to rate |
| | | | | Filters | the individual |
| 5. Vietnam | $50 | Filter | NAC | Risky | threat level of |
| | | | | Filters | each domain so |
| 6. Russia | $50 | Filter | NAC | Risky | the proper risk |
| | | | | Filters | assessment and |
| 7. Saudi Arabia | $50 | Filter | NAC | Risky | score can be |
| | | | | Filters | applied to the |
| 8. Pakistan | $50 | Filter | NAC | Risky | Filter. |
| | | | | Filters | AI will use ARIN to |
| 9. Egypt, Ethiopia, | $50 | Filter | NAC | Risky | determine Internet |
| Uzbekistan (tie) | | | | Filters | Domain ownership |
| 10. Belarus, United | $50 | Filter | NAC | Risky | and scan the |
| Arab Emirates (tie) | | | | Filters | internet of things |
| | | | | | (IoT) of security |
| | | | | | databases for |
| | | | | | breaches and data |
| | | | | | loss. |
| | | | | | AI will score the |
| | | | | | domain, provide |
| | | | | | security |
| | | | | | justification (with |
| | | | | | sources), and |
| | | | | | create a script to |
| | | | | | the NAC to |
| | | | | | execute the filters. |
| | | | | | AI will continually |
| | | | | | monitor the |
| | | | | | Service Provider |
| | | | | | and will disable |
| | | | | | the Filters when |
| | | | | | the Service |

Scoring the Community Store for Partner Access

| Community | | Filter, | | | |
|---|---|---|---|---|---|
| Store | Gaming | Protocol, | | | |
| Options | Score | or Service | Platform | Description | Definition |
| Authorized | $100 | Service | NAC | Provides a | The Community Store is |
| Partner | | | | customer with | important for Stealth |
| gCOI keys | | | | secured access | customers to gain secure |
| | | | | to partners and | access to Stealth Partner |
| | | | | their networks | networks. Utilizing the |
| | | | | | Stealth Import\Export |
| | | | | | function, the Community |
| | | | | | Store will store Stealth |
| | | | | | keys that will be shared |
| | | | | | between Stealth enclaves. |
| | | | | | The Community Store will |
| | | | | | authenticate the owner |
| | | | | | and partner before |
| | | | | | sharing the Stealth keys. |
| | | | | | Each key will be assigned |
| | | | | | by the owner and the |
| | | | | | partner, but can be |
| | | | | | revoked by the owner or |
| | | | | | the partner. |

Various modifications can be made in the details of the various embodiments of the articles and processes of the present invention, all within the scope and spirit of the invention as defined by the appended claims.

1. A process for enhancing the network security of an entity, the process comprising:
a) collecting network configuration and network environment information from network users, the information including the identification of suppliers of goods and services to the entity;
b) parsing the network configuration and network environment information to identify individual security risks associated with hardware devices, the network configuration, and the network environment comprising individual suppliers of goods and services, and assigning a value to each security risk identified;
c) determining a cumulative security score for each user including the values assigned to each security risk;
d) communicating the cumulative security score to each user;
e) offering the network users suggested changes to the network configuration including devices connected or connectable to the network, and/or changes to the network environment to each user to improve the cumulative security score.

2. The process according to claim 1 further comprising receiving at least one response from a network user to the suggested changes, and recalculating the cumulative security score based on the at least one response.

3. The process according to claim 1, wherein the entity is comprised of a plurality of sub-entities, each sub-entity including at least one network user.

4. The process according to claim 3, wherein the calculation of the cumulative security score is a function of the number of sub-entities.

5. The process according to claim 3, wherein each sub-entity has at least one attribute.

6. The process according to claim 1, wherein the suggested changes are offered at a cost to each user.

7. The process according to claim 6, wherein the cost offered to each user is a function of the identity of the user.

8. The process according to claim 6, wherein the suggested changes include Stealth™ security services.

9. An incremental process for providing a secured network, the process comprising:
a) assessing the configuration of an existing network, including users and devices;
b) identifying communities of interest employing the existing network;
c) defining a network security policy;
d) segmenting the existing network into client nodes, each client node being identified as belonging to at least one community of interest;
e) providing a security filter, consistent with the network securing policy, for each Network Access Control platform governing the existing network; and
f) monitoring traffic, user behavior, and system processes on the existing network to detect unusual behavior associated with specific devices, users, or system processes, and isolating devices, users, or system processes manifesting the unusual behavior from the existing network.

10. The incremental process of claim 9 further comprising providing a centralized firewall for the existing network.

11. The incremental process of claim 10 further comprising providing public cloud hosting for internal services.

12. The incremental process of claim 11 further comprising providing a primary secure server for the existing network.

13. The incremental process of claim 12 further comprising identifying portions of the existing network servicing departmental business activities and providing secure servers for each such portion of the existing network.

14. The incremental process of claim 9, wherein the security filter is derived at least in part from a real-time security assessment for each local and public network portion of the existing network.

15. The incremental process of claim 14, wherein real-time security assessment is based on a machine learning process.

16. The incremental process of claim 9, wherein the real-time security assessment includes a numerical score reflective of the security risk, a set of security filter sets, and a set of commands to implement the security filter sets on each Network Access Control platform.

17. The incremental process of claim 9, the process further comprising:
a) collecting public network hosting providers for services, the information including the identification of supplier's goods and services of the entity;
b) scaling hosting configuration for all users, the information including an automated, self-service, repeatable configuration including setup, operations, and support.

18. The incremental process of claim 9, the process further comprising:
a) defining a shared access network security policy;
b) identifying communities of interest employing the shared network
c) defining a network security policy exchange process;
d) segmenting both networks into user and server client nodes, each client node being identified as having a shared community of interest.
